(19) United States
(12) Patent Application Publication
(10) Pub. No.: US 2024/0217188 A1
(43) Pub. Date: Jul. 4, 2024

(54) Device for Welding a Flexible Medical Tube

(71) Applicant: MACO PHARMA, Mouvaux (FR)

(72) Inventor: Hervé Unal, La Salvetat-Belmontet (FR)

(21) Appl. No.: 18/400,773

(22) Filed: Dec. 29, 2023

(30) Foreign Application Priority Data
Dec. 30, 2022 (FR) FR2214683

(51) Int. Cl. B29C 65/00; B29C 65/04

(52) U.S. Cl. CPC B29C 66/857; B29C 65/04; B29C 66/5221; B29C 66/91655; B29C 66/9241; B29C 66/8322

(57) ABSTRACT

A device for welding a flexible tube by radio frequency includes:
a clamping member having a welding head formed by a first electrode and a second electrode,
a power source configured to supply electrical power to the welding device, and
a welding member having a radiofrequency generator and a radiofrequency power converter, the first and second electrodes, the power source, the radio-frequency generator and the power converter forming between them an electrical circuit having an impedance, the power converter including at least two inductors connected in series with the first and second electrode of the welding member and an electrical current flow control element configured to cut off the flow of the electrical current in one of the inductors so as to maintain the impedance of the electrical circuit constant during welding.

The present invention concerns a device for welding a flexible tube by radiofrequency as well as an apparatus comprising such a device.

It applies to the medical and biomedical field, in particular to the domain of treatment of blood or biological cells, and to the perfusion field.

For the collection of donor blood and its subsequent processing, bag systems are known to be used, comprising one or more bags connected together by flexible tubes to form a closed system. In particular, these bags and tubes are made of a flexible thermoplastic material such as plasticized polyvinyl chloride or ethylene vinyl acetate. To isolate the various elements of such bag systems, it is also known to weld these tubes using a welding apparatus. These welding apparatuses are either portable, so that they can be held in a user's hand, or fixed, so that they can be placed on a work surface. In the case of portable welding apparatuses, a distinction is made between cordless welding apparatuses with an integral battery and welding apparatuses connected by a wire to an external battery.

The principle behind these welding apparatuses is to apply heat to the tube to start melting it, while at the same time applying pressure to the tube to weld the tube walls together. In the case of a radio-frequency (RF) welder, the plastic tube is placed between two electrodes, and a high-frequency (HF) signal is generated between these two electrodes, causing dielectric loss and a rise in tube temperature. Welding is achieved by bringing the electrodes together until the tube is pinched.

However, the distance between the electrodes changes during welding, resulting in a change in impedance. This impedance change adversely affects weld quality by detuning the resonant frequency, and greatly reduces the welder energy efficiency of the welder.

Yet, in the case of portable cordless welding apparatuses in particular, maximum energy efficiency is required to ensure that such apparatuses can achieve a weld number autonomy greater than five hundred welds, while keeping their weight to a minimum.

In order to reduce the power consumption of such welders, document U.S. Pat. No. 5,750,971 describes a portable or stationary welder in which the RF generator generates RF energy at constant voltage and time-varying power in relation to impedance change.

To reduce the effects of impedance mismatch, document WO 2016/079702 proposes a portable welder essentially comprising a welding head equipped with a clamp with electrodes, a radio frequency (RF) generator comprising an oscillator and a first and second amplification stage, a power supply unit, a control board, and a high-voltage inductor. The high-voltage inductor is configured to transform the signal generated at the output of the RF generator into a high-voltage RF signal and to perform a precise adjustment of the impedance matching.

Document WO 2016/083459 describes a portable cordless welder comprising a clamp consisting of a pair of jaws provided with two electrodes, a high-frequency electrical power supply circuit comprising a high-frequency (HF) generator with a variable-impedance HF circuit and an impedance control device. In the variable-impedance circuit, the capacitance of the capacitor and/or the inductance of the associated coil and/or the ohmic resistance of the HF resonant circuit are adjustable. The impedance control device is configured to maintain the impedance of the HF electrical power supply circuit constant during welding. In particular, impedance adjustment is coupled to the movement of the welding machine jaws.

Document EP4 009 744 A1 describes a stationary welder for welding a flexible medical tube by radio frequency. The welder comprises a pair of electrodes connected to a control circuit. The control circuit comprises an RF generator and an inductor connected in series with an adjustable capacitor. The adjustable capacitor is itself connected in parallel with the capacitor formed by the electrodes. To match the capacitance of the adjustable capacitor to the inductance of the inductor, a bias source applies a bias voltage to the adjustable capacitor to adjust its capacitance.

The flexible tube welding device according to the invention allows to maximize its energy efficiency, so as to make it portable and capable of achieving an autonomy of more than five hundred welds.

Indeed, the device of the invention for welding a flexible tube by radio frequency comprises:
a clamping member comprising a welding head formed by a first electrode and a second electrode,
a power source configured to supply electrical power to the device for welding, and
a welding member comprising a radio-frequency generator and a radio-frequency power converter, said first and second electrodes, said power source, said frequency generator and said power converter forming between them an electric circuit having an impedance, said power converter comprising at least two inductors connected in series with the first and second electrode of the welding member and an electric current flow control element configured to cut off or establish the electric current flow in one of the inductors so as to maintain the impedance of the electric circuit constant during welding.

According to another aspect, the invention concerns an apparatus comprising such a device for welding a flexible tube.

The annexed drawings illustrate the invention:

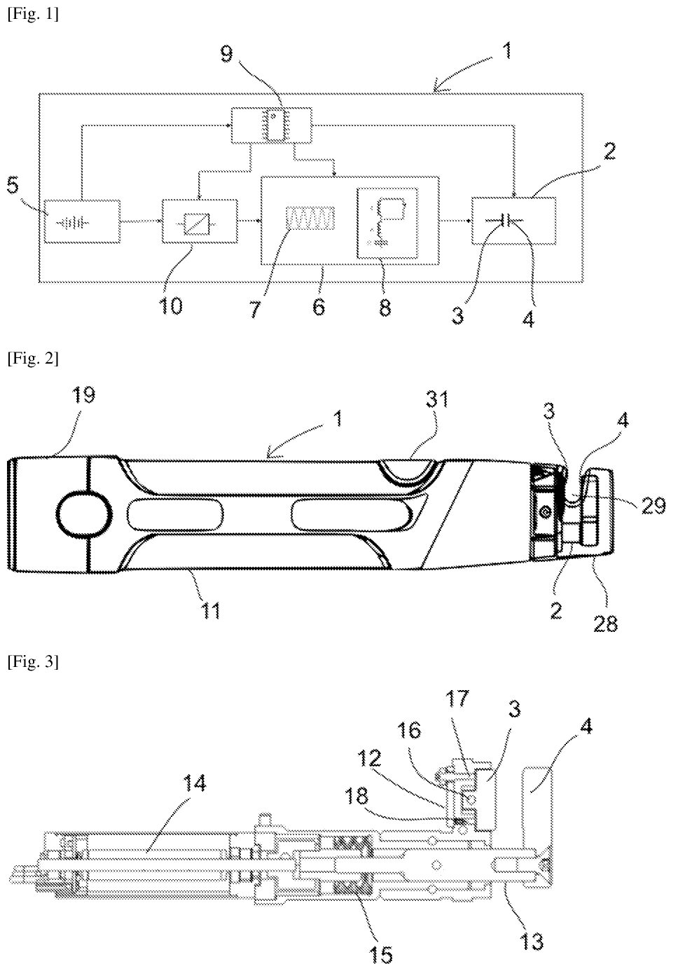

FIG. 1 shows a schematic diagram of the flexible tube welding device of the invention.

FIG. 2 shows a side view of the flexible tube welding device of the invention.

FIG. 3 shows a cross-sectional view of the clamping member of the welding device of the invention.

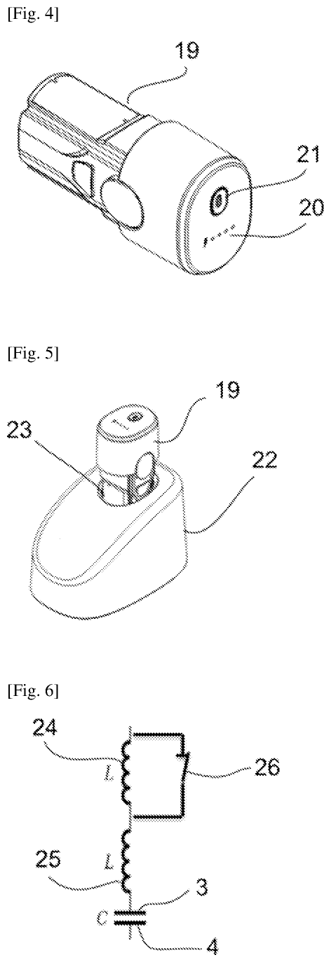

FIG. 4 shows a perspective view of a removable battery of the welding device of the invention.

FIG. 5 shows a perspective view of a removable battery of the welding device of the invention, placed in a charging device.

FIG. 6 shows a schematic diagram of a part of the electrical circuit of the welding device of the invention.

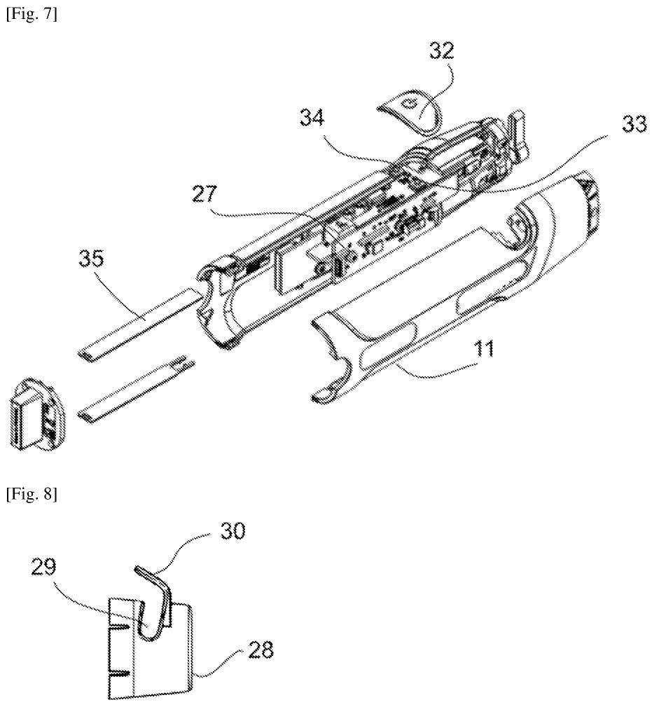

FIG. 7 shows an exploded view of the various components of the welding device of the invention.

FIG. 8 shows a side view of a variant of the tube-receiving element of the welding device of the invention.

With reference to the schematic diagram shown in FIG. 1, the device 1 for welding a flexible tube by radio frequency comprises:
a clamping member 2 comprising a welding head formed by a first electrode 3 and a second electrode 4,
a power source 5 configured to supply electrical energy to the welding device 1,
a welding member 6 comprising a radio-frequency generator 7 and a radio-frequency power converter 8,
an energy adapter 10 configured to adapt the energy produced by the power source 5 to the radio-frequency generator 7, and
a control unit 9 configured to control at least the clamping member 2, the power source 5 and the welding member 6.

The flexible tube is a tube made from thermoplastic material such as plasticized polyvinyl chloride or ethylene vinyl acetate. This type of flexible tube to be welded is generally used in the medical or biomedical field.

More particularly and according to FIG. 2, the welding device 1 comprises a substantially cylindrical body 11 configured to be held in a user's hand. According to this embodiment, the welding device 1 is an apparatus for welding a flexible tube.

In a variant not shown, the welding device is arranged in a more complex apparatus used in combination with a medical device comprising a flexible tube. Such apparatuses are, for example, a blood collection apparatus such as that described in document WO20208023A1 or an apparatus for separating and extracting blood components such as that described in document WO2014006339A1.

The clamping member 2, into which a flexible tube (not shown) is inserted for welding, is arranged in the front part of the body 11. The clamping member 2 comprises a welding head formed by a first electrode 3 and a second electrode 4.

Referring to FIG. 3, the clamping member 2 of the device 1 for welding comprises a welding head having a bearing element 12 with the first electrode 3 and a clamping element 13 with the second electrode 4, movable relative to the bearing element 12.

The clamping element 13 is movable between an open position in which a flexible tube placed between the two electrodes 3,4 is undeformed, a clamping position in which a flexible tube placed between the two electrodes 3,4 is obturated and a welding position in which a flexible tube placed between the two electrodes 3,4 is compressed. Between the obturating position and the welding position, additional pressure is applied to the flexible tube.

The first and second electrodes 3,4 are made of an electrically conductive material capable of generating a radio-frequency electric field. These electrodes and the electric field act as a capacitor.

The clamping member 2 further comprises a drive means 14 arranged to produce a movement and transmit it to said clamping element 13. In a particular embodiment, the drive means 14 is configured to linearly displace the clamping element 13.

For example, the drive means 14 is an electric motor coupled to a worm screw. Alternatively, the drive means may be a linear stepper motor, a DC or AC motor, a brushless motor, or a pneumatic or hydraulic cylinder.

In order to reduce the size of the clamping member 2, the drive means 14 is coupled to an elastic element 15, such as a compression spring. In a first phase and by means of the worm screw, the drive means 14 moves the second electrode 4 of the clamping element 13 towards the first electrode 3 of the bearing element 12 until reaching the clamping position in which the tube to be welded is obturated. At the end of this phase, the compression spring is constrained by the presence of the tube to be welded. In a second phase, corresponding to the sending of a radio-frequency signal, the spring relaxes as the tube softens, bringing the first electrode 3 and the second electrode 4 closer together until the welding position is reached, in which the flexible tube is compressed to produce the weld.

For good quality welding, the first electrode 3 and the second electrode 4 each comprise a substantially flat surface parallel to each other.

As shown in FIG. 3, in order to be able to adjust the parallelism of these electrodes, the first electrode 3 can be rotated relative to a rod 16 of the clamping member 2. This rod 16, which forms the axis of rotation, is placed parallel to the axis of the flexible tube to be welded when it is placed between the first and second electrodes 3,4. A first screw 17 and a second screw 18 are arranged transversely to said rod 16, in contact with the top rear part and the bottom rear part of the first electrode 3, respectively. By tightening or loosening either one of the other screw 17,18, the first electrode 3 is brought parallel to the second electrode 4.

The welding device 1 also includes a power source 5 configured to supply it with electrical power. In particular, the power source 5 supplies electrical power to the radio frequency generator 7 via the power adapter 10.

As shown in FIG. 4, this power source is in particular a battery 19. Advantageously, the battery 19 is removably integrated in the welding device 1, i.e. it is configured to be reversibly placed in the body 11 of the welding device 1. Thanks to this integrated battery, the welding apparatus does not comprise a wire connecting it to an external element, which facilitates its handling.

In particular, the battery 19 can be snapped into the body 11 of the welding device 1, on the rear part, i.e. the part opposite the welding head comprising the two electrodes 3, 4.

In a particular embodiment, the battery 19 comprises a luminous charge indicator 20 in the form of a series of light-emitting diodes and a charge button 21 which the user presses to illuminate the series of diodes and check the charge level of the battery.

The battery is, for example, of the lithium, lithium-ion, lithium titanate, nickel, nickel-cadmium, nickel-manganese-cobalt, nickel-iron, nickel-metal hydride or lithium iron phosphate type. Advantageously, the battery has an energy density greater than 90 Wh/kg, in particular greater than 150 Wh/Kg. This energy density provides sufficient autonomy to perform more than 500 welds per charge in a relatively small size. In addition, the battery has a discharge current greater than 10 A, in particular greater than 20 A. This current is sufficient to power the radio-frequency generator of the welding member.

FIG. 5 shows a charging device 22 in which a removable battery 19 is arranged. This charging device 22 comprises a means 23 for receiving the battery 19. This receiving means 23 is, for example, a hollow part in the body of the charging device. In a variant not shown, the charging device comprises at least two battery-receiving means so that several batteries can be recharged at the same time.

In a particular embodiment, the welding device 1 comprises an energy adapter 10 configured to adapt the energy produced by the power source 5 to the radio frequency generator 7. In particular, the power adapter 10 is a voltage converter which transforms the voltage of the current generated by the battery 19 into a voltage usable by the radio frequency generator 7. For example, the voltage converter enables a voltage of around 50 V to be supplied to the radio frequency generator from the 5 V voltage supplied by the battery 19. The voltage converter maintains the electrical power of the battery 19.

The welding device 1 further comprises a welding member 6 configured to weld the flexible tube by radio frequency. The welding member 6 comprises the radio-frequency generator 7 and a radio-frequency power converter 8.

The capacitor formed by the first and second electrodes 3,4, the power source 5, the frequency generator 7 and the power converter 8 together form an electrical circuit. This electrical circuit may include other components of the welding device, such as the power adapter 10.

This electrical circuit has a resonant frequency at which energy consumption is the lowest. At this resonance frequency, energy transfer is optimal. During the welding operation, the impedance of the electrical circuit varies according to the distance between the first and second electrodes 3,4.

The RF generator comprises an oscillator configured to generate a high-frequency signal, in particular a signal with a frequency of 40.68 MHz. For example, the oscillator is a quartz resonator oscillator or of the Micro Electro-Mechanical System (MEMS) oscillator type.

The RF generator further comprises one or more amplifiers designed so that the RF generator delivers an output power greater than 80 watts, in particular of around 100 watts.

The welding member 6 also includes a radio-frequency power converter 8 designed to transform the RF signal at the output of the RF generator into a heat signal.

Advantageously, the power converter 8 includes a frequency rejection filter to retain substantially only the resonant frequency in order to absorb its energy. For example, the rejection filter comprises an inductor and a capacitor connected in parallel with the RF generator and a resistor.

As shown in FIG. 6 and according to the invention, the radio-frequency power converter 8 further comprises at least two series-connected inductors 24, 25 and an electric current flow control element 26 configured to cut off the flow of said electric current in one of the inductors so as to maintain the impedance of the electric circuit constant during welding. The electric current flow control element 26 is further configured to restore the electric current in the deactivated inductor before the start of the next weld.

For example, inductors 24, 25 are designed as one or more coils with constant, i.e. non-variable, inductance. In particular, the power converter 8 comprises three series-connected coils, at least one of which can be switched off by the electric current flow control element 26.

Advantageously, one or more of the coils includes an inductance amplification element, such as a ferrite fixed in the coil. This embodiment contributes to the miniaturization of the welding member by enabling the use of small coils.

The electrical current flow control element 26 is, for example, an electrical relay or an electromechanical switch configured to open and close the contactors of an electrical circuit.

In one configuration, these inductors 24,25 are connected in series with the capacitor formed by the first and second electrodes 3,4 of the clamping member 2.

During welding, the distance between the first electrode 3 and the second electrode 4 and the presence of the tube change the impedance of the electrical circuit, resulting in a loss of energy efficiency as the resonant frequency deviates from the circuit frequency. This phenomenon is known as resonant frequency detuning. By short-circuiting one of the inductors 24,25 at the moment of resonance frequency detuning, the impedance of the electrical circuit is kept substantially constant, thus providing good energy efficiency.

Impedance is maintained without changing the RF signal frequency.

The resonant frequency detuning is detected indirectly by continuously determining the current drawn by the RF generator and/or the radiofrequency fields emitted around the inductors and/or directly by determining the RF signal.

The selectivity associated with such a resonant electrical circuit comprising the inductors 24,25 and the capacitor formed by the electrodes 3,4 connected in series is advantageous over a parallel connection, as it increases the loss of dielectric charges. This selectivity is further enhanced by the use of ferrite in the coils, as described above, which allows to reduce series resistance.

The welding device 1 further comprises a control unit 9 configured to control at least the clamping member 2, the power source 5 and the welding member 6.

In particular, the control unit 9 is configured so that, in the event of a resonant frequency detuning during welding, it activates the electric current flow control element 26 in order to switch off one of the inductors 24, 25.

By switching off one of the inductors 24,25, the impedance of the circuit formed by the capacitor formed by the pair of electrodes 3,4 and the inductors 24,25 is kept constant.

As seen above, resonant frequency detuning is detected indirectly by continuously determining the current drawn by the RF generator and/or the radiofrequency fields emitted around the inductors and/or directly by determining the RF signal.

On the basis of this monitoring information, the control unit also detects when the welding process has been completed and whether it has proceeded correctly. The control unit 9 emits a signal informing that the welding process has not been completed correctly, if applicable.

In particular, the control unit 9 is configured to control the drive means 14 of the clamping member 2 and the triggering of the radio frequency generator 7.

The control unit 9 is also configured to detect the presence, absence and/or thickness of a tube to be welded between the electrodes 3, 4. For example, the control unit 9 is configured to analyze the current consumed by the drive means 14 during the first welding phase. The control unit 9 is then configured to emit a signal in the event of the absence of a flexible tube.

The control unit 9 is in the form of an electronic and computer system which includes, for example, a microprocessor designed to execute a control program. Execution of this program enables the control unit 9 to control the welding device 1 according, for example, to the impedance of the electrical circuit formed by the electrodes 3,4, the power source 5, the radio-frequency generator 7 and the power converter 8.

The control unit 9 also analyzes the monitoring information to detect when the welding process has ended and whether it has been completed correctly. The control unit 9 sends a signal informing that the welding process has not been completed correctly, if applicable.

As shown in FIG. 7, the welding element 6 and the control unit 9 are constructed as a set of printed circuit boards 27 arranged around the clamping element 2. This arrangement forms a Faraday cage which at least partially blocks electromagnetic fields that could adversely affect the operation of the welding device 1 or the operation of other apparatuses in the vicinity of the welding device 1.

According to FIG. 2, the body 11 of the welding apparatus further comprises a tube-receiving element 28 configured to receive the tube to be welded. According to FIG. 2, the tube-receiving element 28 covers the welding head of the clamping member 2. The tube-receiving element 28 is further provided with a slot 29 designed to accommodate the tube to be welded and position it correctly in the welding head between the two electrodes 3,4. Advantageously, the tube-receiving element 28 is transparent, enabling the user to check that the tube to be welded is correctly positioned in the welding head. In particular, the tube-receiving element 28 is removable so that it can be cleaned and replaced by another tube-receiving element.

FIG. 8 shows a tube-receiving element 28 in one variant. In this embodiment, one edge of the slot 29 in which the tube is housed is extended outwards by a curved tongue 30 extending over the opening of the slot 29. This tongue 30 protects the user from splashes of liquid contained in the tube to be welded, which may splash back in the event of a leak in said tube.

Referring to FIG. 2, an actuator 31 in the form of a button assembly is provided to operate the welding device 1. This actuator 31 is configured to initiate the welding operation as described below.

In FIG. 7, the actuator comprises a button part 32 incorporated in the body 11 of the welding apparatus, which the user presses to engage the device for welding. The actuator further comprises two push buttons 33,34 operable via a blade 35 arranged between the push buttons and the button part 32. The blade 35 is designed to press either or both of the push buttons 33,34 when pressure is applied to the button part 32 of the actuator 31. This blade 35 also allows the button part 32 to return to its initial position when the button part 32 is no longer pressed. The blade 35 is made of epoxy polymer, for example.

In particular, the button part 32 is large enough for the actuator 31 to be easily engaged by the user regardless of the position of the welding apparatus. The two push-buttons 33,34 combined with the blade 35 ensure that the actuator 31 is triggered wherever the user presses the button 32.

According to one embodiment, the welding device 1 further comprises a welding tracking indicator. For example, the tracking indicator is a light indicator comprising one or more light-emitting diodes. Each welding stage—start, progress, end—is indicated by the lighting up of a diode of a specific color. These diodes are located in particular at the actuator 31.

The operation of the welding device 1 of the invention is described below.

The control unit 9 is configured to implement a process for welding a flexible tube using the welding device 1 of the invention comprising the following steps:
activating the clamping member 2 so that the electrodes 3,4 clamp the tube to be welded,
after detection of the tube to be welded, activating the welding member 6 so as to trigger the radio-frequency generator 7 and generate a high-frequency signal between the two electrodes 3,4,
after detection of a resonance frequency detuning, activate the electric current flow control element 26 of the power converter 8 to maintain the electrical circuit impedance constant,
after detection of another resonance frequency detuning, which indicates the end of welding, switch off the radio-frequency generator 7, and
activate the clamping member 2 to release the welded tube from the first and second electrodes 3,4.

The first activation of the clamping member 2 causes the clamping element 13 to move from the open position to the clamping position. In particular, the clamping member 2 is activated via the actuator 31.

When the welding element 6 is triggered, the clamping element 13 moves from the clamping position to the welding position.

The last activation of the clamping member 2 causes the clamping element 13 to move from the welding position to the open position.

Advantageously, the welded flexible tube is released after a cooling period during which the tube is compressed between the two electrodes 3, 4 and the RF generator 7 is switched off. This cooling time allows the welded tube to drop in temperature to allow the weld to set.

This cooling time is either fixed or variable, depending on the internal temperature of the welding device 1.

1. A device for welding a flexible tube by radio frequency comprising:
a clamping member comprising a welding head formed by a first electrode and a second electrode,
a power source configured to supply electrical power to the welding device, and
a welding member comprising a radio-frequency generator and a radio-frequency power converter, said first and second electrodes, said power source, said radio-frequency generator and said power converter forming between them an electrical circuit having an impedance, said power converter including at least two inductors connected in series with the first and second electrodes of the welding member and an electric current flow control element configured to cut off the flow of said electric current in one of the inductors so as to maintain the impedance of the electric circuit constant during welding.

2. The welding device as claimed in claim 1, further comprising an energy adapter configured to adapt the energy produced by the power source to the radio frequency generator.

3. The welding device according to claim 1, further comprising a control unit configured to control at least the clamping member, the power source and the welding member.

4. The welding device according to claim 3, the control unit being configured to activate the electric current flow control element in the event of a resonant frequency detuning during welding, in order to switch off one of the inductors.

5. The welding device according to claim 3, the control unit being configured to emit a signal in the event of a missing flexible tube.

6. The welding device according to claim 1, the welding head comprising a bearing element with the first electrode and a clamping element with the second electrode, said clamping element being movable relative to the bearing element.

7. The welding device according to claim 1, the clamping member further comprising a drive means for linearly displacing the clamping element.

8. The welding device according to claim 1, the drive means being coupled to an elastic element.

9. The welding device according to claim 1, the power source being a battery removably integrated in the welding device.

10. The welding device according to claim 1, the first electrode being rotatable relative to a rod of the clamping member, said rod being placed parallel to the axis of the flexible tube to be welded.

11. The welding device according to claim 1, further comprising an actuator for operating the welding device, said actuator comprising a button assembly formed by a button part and two push buttons operable via a blade arranged between the push buttons and the button part.

12. (canceled)
